(19) United States
(12) Patent Application Publication
(10) Pub. No.: US 2023/0272150 A1
(43) Pub. Date: Aug. 31, 2023

(54) PREPARATION OF LOW ODOR POLYURETHANE FOAMS

(71) Applicant: Dow Global Technologies LLC, Midland, MI (US)

(72) Inventors: Praveenkumar Boopalachandran, Rosharon, TX (US); Daniel G. Abebe, Lake Jackson, TX (US); Kefu Sun, Sugar Land, TX (US); Scott T. Matteucci, Midland, MI (US); Luis Garcia, Richwood, TX (US); Beata A. Kilos, Midland, MI (US)

(21) Appl. No.: 18/004,124

(22) PCT Filed: Sep. 14, 2021
(86) PCT No.: PCT/US2021/050159

§ 371 Date: Jan. 3, 2023

Related U.S. Application Data
(60) Provisional application No. 63/078,472, filed on Sep. 15, 2020.

(51) Int. Cl. C08G 18/08; C08K 3/36; C08G 18/32

(52) U.S. Cl. CPC C08G 18/14; C08K 3/36; C08G 18/3206; C08G 2110/0083

(57) ABSTRACT

A method for preparing low odor polyurethane foams by the use of a high silica zeolite and a foam-forming composition.

### FIELD

The present disclosure relates to the use of a high silica zeolites in the production of foams. More particularly, the present disclosure relates to a foam-forming composition comprising at least a high silica zeolite and a process to produce polyurethane (PUR) foams.

### INTRODUCTION

Flexible Polyurethane (PU) foams are used in various consumer comfort and automotive applications. However, these foams have an inherent odor issue originating from the volatile molecules trapped in the foams which are slowly released through diffusion over a course of time and/or during use by consumers. Emission of volatile molecules in the end product can raise both regulatory and quality concerns, therefore PU foams with minimal volatile content are highly desirable. The volatile molecules in PU foams can originate from unreacted monomers or by-product molecules formed from the alkoxylation reaction used to manufacture polyols. They may also originate from catalysts, surfactants, flame retardants, antioxidants, etc. Typically, these unwanted volatiles are removed post alkoxylation through time consuming and economically undesirable stripping methods. Thus, there is a need for a composition and/or method of production which produces polyurethane foams with reduced odor.

### SUMMARY

A purpose of the present disclosure is to provide a composition for producing polyisocyanurate (PIR) and polyurethane (PUR) foams, a process for preparing PUR foams, and a novel high silica zeolite additive for preparing PUR foams, and foams made therewith.

The incorporation of said zeolites into a PU foam results in a low odor or odor free composition. It was surprisingly found that a high silica zeolites with low affinity for H2O molecules have a tremendous selectivity for nonpolar and polar organic molecules. These zeolites are porous and can physically adsorb small organic molecules in the presence of H2O and do not freely release the adsorbed molecules, even when heated to 200° C. The hydrophobic nature of the high silica zeolites prevents displacement of adsorbed VOC molecules by H2O molecules. Compared to other commercially available zeolites, the high silica alternatives show significant reduction in VOC molecules, specifically odor causing molecules at relatively low loading levels.

In one embodiment, the flexible polyurethane foam produced has a decrease in total aldehyde content by greater than 80% (less than 10 ppm) compared to foams produced via currently known methods. Another embodiment achieves a decrease in total VOC content by greater than 50% as compared to traditional production methods in addition to or in place of the decreased aldehyde content. In both these embodiments, there is no change in mechanical and physical properties of the resulting foam as compared to traditional production methods.

Additionally, due to inert nature of these zeolites, there is minimal impact on mechanical and physical properties of the resulting foams when incorporated during the foaming process enabling the production of flexible foams used for automotive applications, mattresses, pillows, furniture, and other consumer comfort applications.

It is to be understood that both the foregoing general description and the following detailed description are exemplary and explanatory only and are not restrictive of the claims.

### DETAILED DESCRIPTION

Unless defined otherwise, all technical and scientific terms used herein have the same meaning as commonly understood by one of ordinary skill in the art to which the method belongs. Also, all publications, patent applications, patents, and other references mentioned herein are incorporated by reference. As disclosed herein, the term “composition”, “formulation” or “mixture” refers to a physical blend of different components, which is obtained by mixing simply different components by a physical means. As disclosed herein, “and/or” means “and, or as an alternative”. All ranges include endpoints unless otherwise indicated.

In various embodiments, a composition for producing flexible polyurethane (PUR) foams is provided, comprising an isocyanate, an isocyanate-reactive component including one or more polyols that can react with the isocyanate groups, a blowing agent, and at least one zeolite additive. Amines and organometallic catalysts may also be included. Without being bound by theory, the isocyanate component and the isocyanate-reactive component are generally stored in separate containers until the moment when they are blended together and subjected to the polymerization reaction between the isocyanate groups and hydroxyl groups to form polyisocyanurate and polyurethane. Polyurethane refers to a polymer comprising a main chain formed by the repeating unit (—NH—C(O)—O—) derived from the reaction between isocyanate group and hydroxyl group.

As used herein, the terms of “polyisocyanurate and polyurethane”, “polyisocyanurate or polyurethane”, “PIR and PUR”, “PIR or PUR” and “PIR/PUR” are used interchangeably and refer to a polymeric system comprising both polyurethane chain and polyisocyanurate groups, with the relative proportions thereof basically depend on the stoichiometric ratio of the polyisocyanate compounds and polyol compounds contained in the raw materials. Besides, the ingredients, such as catalysts and other additives, and processing conditions, such as temperature, reaction duration, etc., may also slightly influence the relative amounts of the PUR and PIR in the final foam product. Therefore, polyisocyanurate and polyurethane foam (PIR/PUR foam) as stated in the context of the present disclosure refer to foam obtained as a product of the reaction between the above indicated polyisocyanates and compounds having isocyanate-reactive groups, particularly, polyols. Besides, additional functional groups, e.g. allophanates, biurets or ureas may be formed during the reaction. The PIR/PUR foam may be a rigid foam or flexible foam. The composition of the present disclosure may further comprise catalyst, blowing agent, and other additives.

According to one broad embodiment of the present disclosure, a foam-forming composition and method of making rigid polyurethane foams for the foam-forming composition comprises three components: an isocyanate component comprising at least one polyisocyanate compound, an isocyanate-reactive component comprising at least one or more polyols, and the high silica containing zeolite.

The high silica containing zeolite may be introduced into the foaming formulation (and resulting foam) in a number of ways. These include mixing the zeolite into the polyol component of the foaming formulation right before the foaming process. Zeolites may also be added into the foaming formulation directly as a powder. The powdered mode of addition could be used in formulated polyol systems for pillows, car seats (premixing of the formulated polyol will be needed, standard practice in systems for discontinuos processes). The powdered mode of addition could be used in box foamer formulations (premixing with the polyol is needed). The powdered modes of addition above rely on stable powdered zeolites, but unstable powdered zeolites could also be used. These unstable powedered zeolites require mixing before and after addition to the polyol. Powdered zeolites can also be added into the polyol for use as a component in flex slab continuous machine production where no premixing is possible.

The zeolites may also be added by any other functionally capable method which enables the zeolites to be embedded upon and/or within the foaming formulation or formed foam. For example, liquid and/or powdered zeolites may be fed as a separate stream into the forming formulation when its components are mixed (e.g., polyol, iscocyante, and zeolite streams mixed at the same time). The zeolite may also be laid down on a substrate (poured, sprinkled, etc.) and the foaming formulation poured upon the zeolite with out mixing or in addition to mixing. The zeolite may also be poured, sprinkled, or otherwise applied to foaming formulation (or rising foam) after the formulation is mixed and poured onto a substrate.

Additionally, other optionally auxiliary components such as surfactant, catalyst, additional blowing agent, flame retardant additive, etc. may be pre-mixed into the isocyanate-reactive component or the isocyanate component, which is then mixed with the other components to produce the PU foam or admixed into the foam-forming composition as separate streams for the foam production. Not all of these optional auxiliary components are required for the foam production and should not be read as limiting the scope of this disclosure in any way.

Various embodiments of the presently disclosed composition may vary in the amounts, contents or concentration of the isocyanate-reactive component and the isocyanate component. The isocyanate component in these embodiments are calculated based on the total weight of the foam-forming composition, i.e. combined weight of the isocyanate-reactive component, the isocyanate component, the zeolite, and all optional auxiliary components if not already accounted for in another component.

### I. Polyurethane Foaming Formulation

Isocyanate Component

In various embodiments, the isocyanate component of the foam-forming composition of the present invention, can include, for example, one or more isocyanate compounds including for example a polyisocyanate. As used herein, “polyisocyanate” refers to a molecule having an average of greater than 1.0 isocyanate (NCO) groups per molecule, e.g. an average NCO functionality of greater than 1.0.

The isocyanate compound useful in the present invention may be an aliphatic polyisocyanate, a cycloaliphatic polyisocyanate, an araliphatic polyisocyanate, an aromatic polyisocyanate, or combinations thereof. Examples of isocyanates useful in the present invention include, but are not limited to, polymethylene polyphenylisocyanate; toluene 2,4-/2,6-diisocyanate (TDI); methylenediphenyl diisocyanate (MDI); polymeric MDI; triisocyanatononane (TIN); naphthyl diisocyanate (NDI); 4,4′-diisocyanatodicyclohexyl-methane; 3-isocyanatomethyl-3,3,5-trimethylcyclohexyl isocyanate (isophorone diisocyanate IPDI); tetramethylene diisocyanate; hexamethylene diisocyanate (HDI); 2-methyl-pentamethylene diisocyanate; 2,2,4-trimethylhexamethylene diisocyanate (THDI); dodecamethylene diisocyanate; 1,4-diisocyanatocyclohexane; 4,4′-diisocyanato-3,3′-dimethyl-dicyclohexylmethane; 4,4′-diisocyanato-2,2-dicyclohexylpropane; 3-isocyanatomethyl-1-methyl-1-isocyanatocyclohexane (MCI); 1,3-diisooctylcyanato-4-methylcyclohexane; 1,3-diisocyanato-2-methylcyclohexane; and combinations thereof, among others. In addition to the isocyanates mentioned above, partially modified polyisocyanates including uretdione, isocyanurate, carbodiimide, uretoneimine, allophanate or biuret structure, and combinations thereof, among others, may be utilized in the present invention.

The isocyanate compound may be polymeric. As used herein “polymeric”, in describing the isocyanate, refers to high molecular weight homologues and/or isomers. For instance, polymeric methylene diphenyl isocyanate refers to a high molecular weight homologue and/or an isomer of methylene diphenyl isocyanate.

The isocyanate compound useful in the present invention may be modified multifunctional isocyanates, that is, products which are obtained through chemical reactions of an isocyanate compound. Exemplary are polyisocyanates containing esters, ureas, biurets, allophanates and carbodiimides and/or uretoneimines Liquid polyisocyanates containing carbodiimide groups, uretoneimines groups and/or isocyanurate rings, having isocyanate groups (NCO) contents of from 10 to 35 weight percent, from 10 to 32 weight percent, from 10 to 30 weight percent, from 15 to 30 weight percent, or from 15 to 28 weight percent can also be used. These include, for example, polyisocyanates based on 4,4′-, 2,4′- and/or 2,2′-diphenylmethane diisocyanate and the corresponding isomeric mixtures, 2,4- and/or 2,6-toluenediisocyanate and the corresponding isomeric mixtures; mixtures of diphenylmethane diisocyanates and PMDI; and mixtures of toluene diisocyanates and PMDI and/or diphenylmethane diisocyanates.

Alternatively, or additionally, the isocyanate component may also comprise an isocyanate prepolymer. The isocyanate prepolymer is known in the art; and in general, is prepared by reacting (1) at least one isocyanate compound and (2) at least one polyol compound. The isocyanate prepolymer can be obtained by reacting the above stated monomeric isocyanate compounds or polymeric isocyanate with one or more isocyanate reactive compounds such as ethylene glycol, 1,2-propanediol, 1,3-propanediol, 1,3-butanediol, 1,4-butenediol, 1,4-butynediol, 1,5-pentanediol, neopentylglycol, bis(hydroxy-methyl) cyclohexanes such as 1,4bis(hydroxymethyl)cyclohexane, 2-methylpropane-1,3-diol, methylpentanediols, diethylene glycol, triethylene glycol, tetraethylene glycol, polyethylene glycol, dipropylene glycol, polypropylene glycol, dibutylene glycol and polybutylene glycols.

Suitable prepolymers for use as the polyisocyanate component are prepolymers having NCO group contents of from 5 to 30 weight percent or preferably from 10 to 30 weight percent. These prepolymers may be prepared by reaction of the di- and/or poly-isocyanates with materials including lower molecular weight diols and triols. Individual examples are aromatic polyisocyanates containing urethane groups, having NCO contents of from 5 to 30 weight percent (e.g., 10 to 30 or 15 to 30 weight percent) obtained by reaction of diisocyanates and/or polyisocyanates with, for example, lower molecular weight diols, triols, oxyalkylene glycols, dioxyalkylene glycols, or polyoxyalkylene glycols having molecular weights up to about 1000. These polyols can be employed individually or in mixtures as di- and/or polyoxyalkylene glycols. For example, diethylene glycols, dipropylene glycols, polyoxyethylene glycols, ethylene glycols, propylene glycols, butylene glycols, polyoxypropylene glycols and polyoxypropylene-polyoxyethylene glycols can be used. Polyester polyols can also be used, as well as alkane diols such as butane diol. Other diols also useful include bishydroxyethyl- or bishydroxypropyl-bisphenol A, cyclohexane dimethanol, and bishydroxyethyl hydroquinone. In one preferred embodiment, a combination of PMDI/TDI may be used as the isocyanate component.

As aforementioned, the isocyanate may have an average functionality of greater than 1.0 isocyanate groups/molecule. For instance, the isocyanate may have an average functionality of from 1.75 to 3.50. All individual values and subranges from 1.75 to 3.50 are included; for example, the isocyanate may have an average functionality from a lower limit of 1.5, 1.75, 1.85, or 1.95 to an upper limit of 3.5, 3.4, 3.3, 3.2, 3.1 or 3.

The isocyanate may have an isocyanate equivalent weight of from 80 g/eq to 300 g/eq. All individual values and subranges from 80 g/eq to 300 g/eq are included; for example, the isocyanate may have an isocyanate equivalent weight from a lower limit of 80 g/eq, 90 g/eq, or 100 g/eq to an upper limit of 300 g/eq, 290 g/eq, or 280 g/eq.

The isocyanate used in the present invention may be prepared by a known process. For instance, a polyisocyanate may be prepared by phosgenation of corresponding polyamines with formation of polycarbamoylchlorides and thermolysis thereof to provide the polyisocyanate and hydrogen chloride; or in another embodiment, the polyisocyanate may be prepared by a phosgene-free process, such as by reacting the corresponding polyamines with urea and alcohol to give polycarbamates, and thermolysis thereof to give the polyisocyanate and alcohol, for example.

The isocyanate used in the present invention may be obtained commercially. Examples of commercial isocyanates useful in the present invention include, but are not limited to, polyisocyanates under the trade names VORANATE™, PAPI™, and ISONATE™, such as VORANATE™ M 220, and PAPI™ 27, all of which are available from Dow, Inc., among other commercial isocyanates such as VORANATE™ T-80, PAPI™ 94 or PAPI™ 23.

Generally, the amount of the isocyanate component may vary based on the end use of the rigid PU foam. For example, as one illustrative embodiment, the concentration of the isocyanate component can be from about 20 wt % to about 80 wt %, or from about 25 wt % to about 80 wt %; or from about 30 wt % to about 75 wt %, based on the total weight of all the components in the foam-forming composition for preparing the PU foams. In one embodiment, the stoichiometric ratio of the isocyanate groups in the isocyanate component to the hydroxyl groups in the isocyanate-reactive component is between about 1.0 and 6, resulting in the formed polyurethane and polyisocyanurate foam having an isocyanate index between 100 and 600. The isocyanate index may have a lower limit from 100, 105, 110, 115, 120, 125, 150, 175, and 180 to an upper limit of 600, 575, 550, 525, 500, 475, 450, 425, 400, 375, 350, 325, and 300.

In other embodiments, there are other types of isocyanate which may be used to form more flexible foams. For instance, memory foam made with PMDI has an isocyanate index <100 (75).

Isocyanate-Reactive Component

In various embodiments of the present disclosure, the isocyanate-reactive component comprises one or more isocyanate-reactive compounds such as polyols selected from the group consisting of aliphatic polyhydric alcohols comprising at least two hydroxyl groups, cycloaliphatic or aromatic polyhydric alcohols comprising at least two hydroxyl groups, araliphatic polyhydric alcohols comprising at least two hydroxyl groups, polyether polyol, polycarbonate polyol, polyester polyol, polyesterether polyol and mixture thereof. In one example, the polyol is selected from the group consisting of C2-C16 aliphatic polyhydric alcohols comprising at least two hydroxyl groups, C6-C15 cycloaliphatic or aromatic polyhydric alcohols comprising at least two hydroxyl groups, C7-C15 araliphatic polyhydric alcohols comprising at least two hydroxyl groups, and combinations thereof. Polyester polyols generally have an average molecular weight from 200 to 5,000. Polyether polyols have an average molecular weight from 100 to 5,000,

In one embodiment, the isocyanate-reactive component comprises a mixture of two or more different polyols, such as a mixture of two or more polyether polyols, a mixture of two or more polyester polyols, or a mixture of at least one polyether polyols with at least one polyester polyols. The isocyanate-reactive component has a functionality (average number of isocyanate-reactive groups, particularly, hydroxyl group, in a polyol molecule) of at least 1.8 and a OH number of 80 to 2,000 mg KOH/g. The OH number of isocyanate-reactive component is preferably from 100 to 1,500 mg KOH/g, more from preferably 120 to 1,000 mg KOH/g, even more preferably from 150 to 750 mg KOH/g, yet even more preferably from 150 to 750 mg KOH/g, and yet even still more preferably from 150 to 500 mg KOH/g.

In general, the average hydroxyl functionality of the polyol compound useful in the present invention, such as those described above, can range from a low as 1.8 to as high as 7.5. For example, the aromatic polyester polyol may have an average hydroxyl functionality from 1.8 to 3.0; and the sucrose/glycerine-initiated polyether polyol may have an average hydroxyl functionality of from 3.0 to 7.5. Therefore, the average hydroxyl functionality of the polyol compound used in the present invention can range from 1.8 to 7.5. All individual values and subranges from 1.8 to 7.5 are included; for example, the polyol compound may have an average hydroxyl functionality from a lower limit of 1.8, 2.0, 2.2, 2.5, 2.7, 3.0, or 3.5 to an upper limit of 7.5, 7.0, 6.5, 6.0, 5.7, 5.5, 5.2, 5.0, 4.8, 4.5, 4.2, or 4.0.

In general, the polyol compound may have an average hydroxyl number ranging from 75 mg KOH/g to 650 mg KOH/g. All individual values and subranges from 75 mg KOH/g to 650 mg KOH/g are included; for example, the polyol compound may have an average hydroxyl number from a lower limit of 75 mg KOH/g, 80 mg KOH/g, 100 mg KOH/g, 125 mg KOH/g, 150 mg KOH/g, or 175 mg KOH/g to an upper limit of 650 mg KOH/g, 600 mg KOH/g, 550 mg KOH/g, 500 mg KOH/g, 450 mg KOH/g, or 400 mg KOH/g.

In general, the polyol compound may have a number average molecular weight of from 100 g/mol to 1,500 g/mol. All individual values and subranges of from 100 g/mol to 1,500 g/mol are included; for example, the polyol compound may have a number average molecular weight from a lower limit of 100 g/mol, 150 g/mol, 175 g/mol, or 200 g/mol to an upper limit of 1,500 g/mol, 1250 g/mol, 1,000 g/mol, or 900 g/mol.

In general, the polyol compound may have a hydroxyl equivalent molecular weight from 50 g/eq to 750 g/eq. All individual values and subranges from 50 g/eq to 750 g/eq are included; for example, the polyol compound may have a hydroxyl equivalent molecular weight from a lower limit of 50 g/eq, 90 g/eq, 100 g/eq, or 110 g/eq to an upper limit of 350 g/eq, 300 g/eq, 275 g/eq, or 250 g/eq.

The polyester polyol is typically obtained by condensation of polyhydric alcohols with polyfunctional carboxylic acids having from 2 to 12 carbon atoms (e.g., 2 to 6 carbon atoms). Typical polyhydric alcohols for preparing the polyester polyol are diols or triols and include ethylene glycol, diethylene glycol, polyethylene glycol such as PEG 200, propylene glycol, dipropylene glycol, polypropylene glycol, butylene glycol, pentylene glycol or hexylene glycol, polyether polyol, glycerol, etc. Typical polyfunctional carboxylic acids are selected from the group consisting of succinic acid, glutaric acid, adipic acid, suberic acid, azelaic acid, sebacic acid, decanedicarboxylic acid, maleic acid, fumaric acid and phthalic acid, isophthalic acid, terephthalic acid, the isomeric naphthalenedicarboxylic acids, and combinations thereof. The average OH functionality of a polyester polyol is preferably at least 1.8, even more preferably at least 2.0. Aromatic polyester polyols are one common type of polyester polyols used in rigid polyurethane foam.

As used herein “aromatic polyester polyol” refers to a polyester polyol including an aromatic ring. As an example, the aromatic polyester polyol may be phthalic anhydride diethylene glycol polyester or may be prepared from the use of aromatic dicarboxylic acid with glycols. The aromatic polyester polyol may be a hybrid polyester-polyether polyol, e.g., as discussed in International Publication No. WO 2013/053555.

Aromatic polyester polyol may be prepared using known equipment and reaction conditions. In another embodiment, the aromatic polyester polyol may be obtained commercially. Examples of commercially available aromatic polyester polyols include, but are not limited to, a number of polyols sold under the trade name STEPANPOL™, such as STEPANPOL™ PS-2352, available from Stepan Company, among others.

The polyether polyols usually have a hydroxyl functionality between 2 and 8, in particular from 2 to 6 and is generally prepared by polymerization of one or more alkylene oxides selected from propylene oxide (PO), ethylene oxide (EO), butylene oxide, tetrahydrofuran and mixtures thereof, with a proper starter molecule or a mixture of multiple starter molecules in the presence of catalyst. Typical starter molecules include compounds having at least two hydroxyl groups or have at least one primary amine group in the molecule. Suitable starter molecules can be ethylene glycol, glycerol, trimethylolprpane, pentaerythritol, castor oil, sugar compounds such as, glucose, sorbitol, mannitol and sucrose, aliphatic amines, and aromatic amines, polyhydric phenols, resols, such as oligomeric condensation products of phenol and formaldehyde and Mannich condensates of phenols, formaldehyde and dialkanolamines, and also melamine, etc.

By way of starter molecules having at least 2 (e.g., from 2 to 8) hydroxyl groups in the molecule, it is possible to further use the following non-limiting examples: trimethylolpropane, glycerol, pentaerythritol, castor oil, sugar compounds such as, glucose, sorbitol, mannitol and sucrose, polyhydric phenols, resols, such as oligomeric condensation products of phenol and formaldehyde and Mannich condensates of phenols, formaldehyde and dialkanolamines, and also melamine. Catalyst for the preparation of polyether polyols may include alkaline catalysts, such as potassium hydroxide, for anionic polymerization or Lewis acid catalysts, such as boron trifluoride, for cationic polymerization. Suitable polymerization catalysts may include potassium hydroxide, cesium hydroxide, boron trifluoride, or a double cyanide complex (DMC) catalyst such as zinc hexacyanocobaltate or quaternary phosphazenium compound. In an embodiment of the present disclosure, the polyether polyol has a number average molecular weight in the range from 100 to 2,000 g/mol. For example, in the range from 125 to 1,500 g/mol, from 150 to 1,250 g/mol from 150 to 1,000 g/mol or from 200 to 1,000 g/mol.

A polyether polyol suitable for use in an embodiment may have an average hydroxyl functionality of 2.0, commonly referred as a diol. The diol may be ethylene glycol, propylene glycol, an ethoxylate of ethylene glycol or propylene glycol, a propyloxylate of ethylene glycol or propylene glycol, etc. Examples of commercially available diols include, but are not limited to, a number of polyols sold under the trade name VORANOL™, such as VORANOL™ 2110-TB, available from The Dow Chemical Company, among others. These others may include, but are not limited to: VORANOL™ 8136, VORANOL™ 3943A, VORALUX™ HL 431, VORALUX™ HN 395, VORANOL™ WK 3140, VORANOL™ 8150, VORANOL™ 4053, VORANOL™ 1447, etc. could be used.

A polyether polyol suitable for use in an embodiment may have an average hydroxyl functionality of 3.0, commonly referred as a triol. The triol may be a glycerol, a trimethylolpropane, an ethoxylate or propyloxylate of glycerol or trimethylolprpane, etc. The triol may be prepared using known equipment and reaction conditions. Examples of commercially available triols include, but are not limited to, a number of polyols sold under the trade name VORATEC™, such as VORATEC™ SD 301, available from The Dow Chemical Company, among others.

A polyether polyol suitable for use in this invention may include a sucrose/glycerine-initiated polyether polyol. The sucrose/glycerine-initiated polyether polyol may include structural units derived from another alkylene oxide, e.g., ethylene oxide or propylene oxide. The sucrose/glycerine-initiated polyether polyol may include structural units derived from styrene-acrylonitrile, polyisocyanate, and/or polyurea. The sucrose/glycerine-initiated polyether polyol may be prepared using known equipment and reaction conditions. For instance, the sucrose/glycerine-initiated polyether polyol may be formed from reaction mixtures including sucrose, propylene oxide, and glycerin. One or more embodiments provide that the sucrose/glycerine-initiated polyether polyol is formed via a reaction of sucrose and propylene oxide. In another embodiment, the sucrose/glycerine-initiated polyether polyol may be obtained commercially. Examples of commercially available sucrose/glycerine-initiated polyether polyols include, but are not limited to, a number of polyols sold under the trade name VORANOL™, such as VORANOL™ 360, VORANOL™ 490, and VORANOL™ 280 available from The Dow Chemical Company (Dow, Inc.), among others.

A polyether polyol suitable for use in this invention may include a sorbitol-initiated polyether polyol. The sorbitol-initiated polyether polyol may be prepared using known equipment and reaction conditions. For instance, the sorbitol-initiated polyether polyol may be formed from reaction mixtures including sorbitol and alkylene oxides, e.g., ethylene oxide, propylene oxide, and/or butylene oxide. The sorbitol-initiated polyether polyol may be capped, e.g., the addition of the alkylene oxide may be staged to preferentially locate or cap a particular alkylene oxide in a desired position of the polyol. Sorbitol-initiated polyether polyols may be obtained commercially. Examples of commercially available sorbitol-initiated polyether polyols include, but are not limited to, a number of polyols sold under the trade name VORANOL™ such as VORANOL™ RN 482, available from The Dow Chemical Company, among others.

A polyether polyol suitable for use in this invention may include polyol compounds that include an amine-initiated polyol. The amine-initiated polyol may be initiated from aromatic amine or aliphatic amine, for example, the amine-initiated polyol may be an ortho toluene diamine (o-TDA) initiated polyol, an ethylenediamine initiated polyol, a diethylenetriamine, triisopropanolamine initiated polyol, or a combination thereof, among others Amine-initiated polyols may be prepared using known equipment and reaction conditions. For instance, the amine-initiated polyol may be formed from reaction mixtures including aromatic amines or aliphatic amines and alkylene oxides, e.g., ethylene oxide and/or butylene oxide, among others. The alkylene oxides may be added into an alkoxylation reactor in one step or via several steps in sequence, wherein in each step, a single alkylene oxide or a mixture of alkylene oxides may be used.

In general, the amount of polyols used herein may range from about 10 wt % to about 80 wt %, or from about 12 wt % to 70 wt %, or from about 15 wt % to 60 wt % or from about 15 wt % to about 55 wt %, or from about 15 wt % to about 50 wt %, based on the total weight of all components in the foam-forming composition for preparing the PUR/PIR foam.

Optional Auxiliary Components

In addition to the above at least one isocyanate-reactive component, at least one isocyanate component, and at least one zeolite additive present in the foam-forming composition for the production of polyurethane/polyisocyanurate foam, the foam-forming composition of the present invention may also include other additional optional auxiliary components, compounds, agents or additives. Such optional component(s) may be added to the reactive mixture with any of the other components in the foam-forming composition (e.g., isocyanate component, isocyanate-reactive component, zeolite additive) or added as a separate stream during the foam production.

The optional auxiliary components, compounds, agents or additives that can be used in the present invention can include one or more optional compounds known in the art for their use or function. For example, the optional components can include as methylene chloride, acetone, water, chain extenders, crosslinkers, expandable graphite, additional physical or chemical blowing agent that may be same or different from the aforementioned blowing agent, foaming catalyst, flame retardant, emulsifier, antioxidant, surfactant, compatibilizing agent, chain-extender, other liquid nucleating agents, solid nucleating agents, Ostwald ripening inhibitors additives, pigment, fillers, solvents including further a solvent selected from the group consisting of ethyl acetate, methyl ether ketone, toluene, and mixtures of two or more thereof; and mixtures of two or more of the above optional additives.

The amount of optional auxiliary compound used to add to the foam-forming composition of the present invention can be, for example, from 0 pts to 50 pts, based on 100 pts of total polyols amount in the isocyanate-reactive component in one embodiment, from 0.1 to 40 pts in another embodiment and from 1 pts to 35 pts in still another embodiment. For example, in one embodiment, the usage amount of additional physical blowing agent, when used, can be from 1 pts to 40 pts, based on 100 pts of total polyols amount in the isocyanate-reactive component. In another embodiment, the usage amount of additional chemical blowing agent, when used, can be from 0.1 pts to 10 pts, based on 100 pts of total polyols amount in the isocyanate-reactive component. In still another embodiment, the usage amount of a flame-retardant additive, when used, can be from 1 pts to 25 pts, based on 100 pts of total polyols amount in the isocyanate-reactive component. In yet another embodiment, the usage amount of a surfactant, when used, is typically from 0.1 pts to 10 pts, based on 100 pts of total polyols amount in the isocyanate-reactive component. In even still another embodiment, the usage amount of a foaming catalyst, when used, is from 0.05 pts to 5 pts, based on 100 pts of total polyols amount in the isocyanate-reactive component. And, in a general embodiment, the usage amount of other additives, when used, can be from 0.1 pts to 10 pts, based on 100 pts of total polyols amount in the isocyanate-reactive component.

Catalyst

Catalyst may include urethane reaction catalyst and isocyanate trimerization reaction catalyst. Trimerization catalysts may be any trimerization catalyst known in the art that will catalyze the trimerization of an organic isocyanate compound. Trimerization of isocyanates may yield polyisocyanurate compounds inside the polyurethane foam. Without being limited to theory, the polyisocyanurate compounds may make the polyurethane foam more rigid and provide improved reaction to fire. Trimerization catalysts can include, for example, glycine salts, tertiary amine trimerization catalysts, alkali metal carboxylic acid salts, and mixtures thereof. In some embodiments, sodium N-2-hydroxy-5-nonylphenyl-methyl-N-methylglycinate may be employed. When used, the trimerization catalyst may be present in an amount of 0.05-5 pts (e.g., 0.1-3.5 pts, or 0.2-2.5 pts, or 0.5-2.5 pts), based on 100 pts of total polyols amount in the isocyanate-reactive component.

Tertiary amine catalysts include organic compounds that contain at least one tertiary nitrogen atom and are capable of catalyzing the hydroxyl/isocyanate reaction between the isocyanate component and the isocyanate-reactive component. Tertiary amine catalysts can include, by way of example and not limitation, triethylenediamine, tetramethylethylenediamine, pentamethyldiethylene triamine, bis(2-dimethylaminoethyl)ether, triethylamine, tripropylamine, tributylamine, triamylamine, pyridine, quinoline, dimethylpiperazine, piperazine, N-ethylmorpholine, 2-methylpropanediamine, methyltriethylenediamine, 2,4,6-tridimethylamino-methyl)phenol, N,N′,N″-tris(dimethyl amino-propyl)sym-hexahydrotriazine, and mixtures thereof. When used, the tertiary amine catalyst may be present in an amount of 0.05-5 pts (e.g., 0.1-3.5 pts, or 0.2-2.5 pts, or 0.5-2.5 pts), based on 100 pts of total polyols amount in the isocyanate-reactive component.

The composition of the present disclosure may further comprise the following catalysts: tertiary phosphines, such as trialkylphosphines and dialkylbenzylphosphines; chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni; acidic metal salts of strong acids such as ferric chloride, stannic chloride; salts of organic acids with variety of metals, such as alkali metals, alkaline earth metals, Al, Sn, Pb, Mn, Co, Ni and Cu; organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate; bismuth salts of organic carboxylic acids, e.g., bismuth octanoate; organometallic derivatives of trivalent and pentavalent As, Sb and Bi and metal carbonyls of iron and cobalt. The total amount of the catalyst component used herein may range generally from about 0.01 pts to about 10 pts in the polyol package in one embodiment, and from 0.05 pts to about 5 pts), based on 100 pts of total polyols amount in the isocyanate-reactive component.

Surfactant

The foam-forming composition of the present invention may include a surfactant, e.g., the surfactant may be added to any one of the components in the foam-forming composition or added as a separate stream during the foam production. The surfactant may be a cell-stabilizing surfactant. Examples of surfactants useful in the present invention include silicon-based compounds such as organosilicone-polyether copolymers, such as polydimethylsiloxane-polyoxyalkylene block copolymers, e.g., polyether modified polydimethyl siloxane, and combinations thereof. Surfactants are available commercially and include those available under trade names such as NIAXT™, such as NIAX™ L 6988; and TEGOSTAB™, such as TEGOSTAB™ B 8462; among others. Examples of surfactants also include non-silicone based organic surfactants such as VORASURF™ 504 and VORASURF™ DC 5043, available from The Dow Chemical Company.

Other surfactants that may be useful herein are polyethylene glycol ethers of long-chain alcohols, tertiary amine or alkanolamine salts of long-chain allyl acid sulfate esters, alkylsulfonic esters, alkyl arylsulfonic acids, and combinations thereof. Such surfactants are employed in amounts sufficient to stabilize the foaming reaction against collapse and the formation of large uneven cells. The amount of surfactant, when used, may be from 0.1 pts to 10.0 based upon 100 pts of total polyols present in the isocyanate-reactive component. All individual values and subranges from 0.1 pts to 10.0 pts are included; for example, the surfactant may be from a lower limit of 0.1 pts, 0.2 pts, or 0.3 pts to an upper limit of 10.0 pts, 9.0 pts, 7.5, or 6 pts, based upon 100 pts of total polyols present in the isocyanate-reactive component.

Blowing Agent

A variety of conventional blowing agents can be used. For example, the blowing agent can be one or more of water, various hydrocarbons, various hydrofluorocarbons, various hydrofluoroolefins, formic acid, noble gases, a variety of chemical blowing agents that produce nitrogen or carbon dioxide under the conditions of the foaming reaction, and the like; and a mixture thereof.

The blowing agent for use in this invention should have a boiling point at atmospheric pressure of from about −30° C. to about 100° C., preferably a boiling point of from about −20° C. to about 80° C., more preferably a boiling point of from about 0° C. to about 80° C., even more preferably a boiling point of from about 5° C. to about 75° C., and most preferably a boiling point of from about 10° C. to about 70° C. Illustrative examples of blowing agents that can be used in the invention include low-boiling hydrocarbons such as heptane, hexane, n- and iso-pentane, technical grade mixtures of n- and isopentanes and n- and iso-butane and propane, cycloalkanes such as cyclopentane and/or cyclohexane, low-boiling ethers such as furan, dimethyl ether and diethyl ether, low-boiling ketones such as acetone and methyl ethyl ketone, alkyl carboxylates, such as methyl formate, dimethyl oxalate and ethylene lactate, various hydrochlorofluorocarbons (HCFCs), hydrofluorocarbons (HFCs) and hydrofluoroolefins (HFOs) such as 1,1-dichloro-2,2,2-trifluoroethane, 2,2-dichloro-2-fluoroethane, pentafluoropropane, heptafluoropropane, hexafluorobutene, (E,Z) 1,1,1,4,4,4-hexafluoro-2-butene and trans-1 chloro-,3,3,3-trifluoropropene, trans-1,3,3,3-tetrafluoroprop-1-ene, 1,3,3,3-tetrafluoropropene, etc. Some of these blowing agents are commercially available materials known as Solstice® LBA, Solstice® GBA, Opteon™ 1100, Opteon™ 1150, etc. Mixtures of these low boiling liquids with each other and/or with other substituted or unsubstituted hydrocarbons can also be used.

In one embodiment, the at least one blowing agent of the invention is selected from the group consisting of aliphatic hydrocarbons having 3 to 7 carbon atoms, cycloaliphatic hydrocarbons having 3 to 7 carbon atoms, and hydrofluoroolefin, or a mixture thereof.

In various embodiments, a blowing agent may be selected based at least in part on the desired density of the final foam. The blowing agent may be added to the polyol side before the isocyanate-reactive component is combined with the isocyanate component or added as a separate stream. The amount of blowing agent is from about 0.1 pts to about 40 pts (e.g., from about 0.5 pts to about 35 pts, from 1 pts to 30 pts, or from 5 pts to 25 pts) based on 100 pts of total polyols amount in the foam-forming composition.

In various embodiments, the foam-forming composition of the present invention may include an additional blowing agent that may be same or different from Component (C). The additional blowing agent may be incorporated to any one of the two components (A) and (B) prior to the foam production or added as a separate stream and mixed online with Components (A), (B), (C), and (D) during the foam production. The additional blowing agent may be selected based at least in part on the desired density of the final foam.

A variety of conventional blowing agents can be used. For example, the blowing agent can be one or more of water, various hydrocarbons, various hydrofluorocarbons, various hydrofluoroolefins, formic acid, noble gases, a variety of chemical blowing agents that produce nitrogen or carbon dioxide under the conditions of the foaming reaction, and the like; and mixtures thereof. Methylene chloride or acetone are sometimes also used.

The chemical blowing agent such as water can be used alone or mixed with other chemical and/or physical blowing agents. Also suitable as chemical blowing agents are organic carboxylic acids such as formic acid, acetic acid, oxalic acid, and carboxyl-containing compounds.

Physical blowing agents can be used such as low-boiling hydrocarbons. Examples of such used liquids are alkanes, such as heptane, hexane, n- and iso-pentane, technical grade mixtures of n- and isopentanes and n- and iso-butane and propane, cycloalkanes such as cyclopentane and/or cyclohexane, ethers, such as furan, dimethyl ether and diethyl ether, ketones such as acetone and methyl ethyl ketone, alkyl carboxylates, such as methyl formate, dimethyl oxalate and ethylene lactate and halogenated hydrocarbons such as methylene chloride, dichloromonofluoromethane, difluoromethane, trifluoromethane, difluoroethane, tetrafluoroethane, chlorodifluoroethanes, 1,1-dichloro-2,2,2-trifluoroethane, 2,2-dichloro-2-fluoroethane, hexafluorobutene, various hydrochlorofluorocarbons (HCFCs), hydrofluorocarbons (HFCs) and hydrofluoroolefins (HFOs) such as 1,1-dichloro-2,2,2-trifluoroethane, 2,2-dichloro-2-fluoroethane, pentafluoropropane, heptafluoropropane, hexafluorobutene, (E,Z) 1,1,1,4,4,4-hexafluoro-2-butene and trans-1 chloro-,3,3,3-trifluoropropene, trans-1,3,3,3-tetrafluoroprop-1-ene, 1,3,3,3-tetrafluoropropene, etc. Some of these blowing agents are commercially available materials known as Solstice® LBA, Solstice® GBA, Opteon™ 1100, Opteon™ 1150, etc. Mixtures of these low boiling liquids with each other and/or with other substituted or unsubstituted hydrocarbons can also be used.

In various embodiments, the amount of the additional blowing agent is from about 0.1 pts to about 40 pts (e.g., from about 0.5 pts to about 35 pts, from 1 pts to 30 pts, or from 5 pts to 25 pts) based on 100 pts of total polyols amount in the isocyanate-reactive component.

Other Optional/Auxiliary Additives

Other optional/auxiliary compounds or additives that may be used in the foam-forming composition of the present embodiments for the production of polyurethane foam may include, for example, other co-catalysts, co-surfactants, toughening agents, flow modifiers, adhesion promoters, diluents, stabilizers, plasticizers, dispersing agents, flame retardant (FR) additive, and mixtures thereof.

In various embodiments, fire performance may be enhanced by including one or more flame retardants. Flame retardants may be halogenated or non-halogenated and may include, by way of example and not limitation, tris(1,3-dichloro-2-propyl)phosphate, tris(2-choroethyl)phosphate, tris(2-chloropropyl)phosphate, triethylphosphate, diammonium phosphate, various halogenated aromatic compounds, antimony oxide, alumina trihydrate, and combinations thereof. When used, the flame retardant may be present in an amount from 0.1 pts to about 30 pts, or about 1 pts to 25 pts, or about 2 pts to about 25 pts, or about 5 pts to about 25 pts, based on 100 pts of total polyols amount in the isocyanate-reactive component.

Other additives such as fillers and pigments may be included for the production of the PIR/PUR foams. Such fillers and pigments may include, in non-limiting embodiments, barium sulfate, calcium carbonate, graphite, carbon black, titanium dioxide, iron oxide, microspheres, alumina trihydrate, wollastonite, glass fibers, polyester fibers, other polymeric fibers, combinations thereof, and the like.

### II. High Silica Zeolites

The high silica zeolite additive may have a silicon to aluminum (Si/Al) ratio of greater than 500. These zeolites are porous and have pore sizes >10 Å, capable of capturing large molecules. The amount of zeolite to the other foam forming composition components may be from 0.1 to 20 wt % zeolite and from 90 to 99.9 wt % urethane prepolymer. Other preferred embodiments may feature 0.2 to 10 wt % zeolite, 0.25 to 2.5 wt % zeolite, etc. Exceeding these relative amounts could affect the physical properties of an adhesive. The zeolites themselves are stable at temperatures up to 600° C. and can also function at (or even below) room temperature.

One example of such a zeolite additive is ABSCENTS 3000 Conc. is a hydrophobic zeolite additive, with a silica-to-alumina ratio of 630, available from Honeywell UoP. In various preferred embodiments, the zeolite may have a silica-to-alumina ratio greater than: 35, 75, 150, 300, 500, and even 600.

The high silica zeolites in the embodiments above and other embodiments may be described as a silica polymorph wherein least 90% (preferably at least 95%) of the framework tetrahedral oxide units are SiO2 tetrahedra (e.g., Silicalite and F-Silicalite). In other embodiments, the zeolite may be described as an aluminosilicate, wherein the SiO2/Al2O3 molar ratios are greater than approximately 18 and preferably greater than approximately 35. These exhibit the requisite degree of hydrophobicity. The SiO2/Al2O3 molar ratio for an aluminosilicate may also be from about 35 and up, preferably from 200 to 500. Such aluminosilicate may be the commercially available zeolites ZSM-5, ZSM-11, ZSM-35, ZSM-23, ZSM-38.

Different zeolite species have different crystalline structures that determine the distribution, shape, and size of the zeolite's pores. Natural zeolites may crystallize in a variety of natural processes, while artificial zeolites may be crystallized, for example, from a silica-alumina gel in the presence of templates and alkalis. There are over 200 known types of zeolite crystal structures. An MFI crystal structure, which may also be referred to as a silicate-1 crystal structure, is a zeolite structure comprising multiple pentasil units connected by oxygen bridges which form pentasil chains, and having the chemical formula: NaₙAlₙSi₉₆₋ₙO₁₉₂·16H₂O, wherein n is greater than zero and less than 27. A faujasite (“FAU”) crystal structure, which may also be referred to a Y-type crystal structure or an IZA crystal structure, is a zeolite crystal structure that consists of sodalite cages which are tetrahedrally connected through hexagonal prisms, and which has a pore formed by a 12-membered ring. In aspects, the composition comprises a zeolite having a mixture of crystal structures, wherein the mixture of crystal structures comprises an MFI crystal structure and an FAU crystal structure.

The zeolites used in various embodiments of the presently disclosed subject matter may also be described by various other physical properties. Non-limiting examples for these properties include: the adsorption capacity of water vapor (at 25° C. and water vapor pressure (p/p0) of 4.6 torr) should not be greater than 10 wt %, and preferably not greater than 6 wt %. The pore diameter should be of at least 5.5 Å, preferably at least 6.2 Å. The zeolite should not contain water in the internal cavities of the microporous structure. The zeolite should also contain less than 2.0 wt % alkali metal on an anhydrous basis. One preferred embodiment features zeolite(s) with an Si/Al molar ratio of 5-650, a pore volume of 0.1-1 cm3/g, a BET value of 50-1000 m2/g, and water adsorption from 5-50 cm3/g. Several zeolites and their various physical properties can be seen in the chart below.

CHART 1
Zeolite Properties

| | Si/Al molar | Crystal | Grain Size |
|---|---|---|---|
| Zeolites | ratio | Structure | (SEM) |
| ABS 2000 | 6 | FAU/MFI | ~250 nm to 2 μm |
| ABS 3000 | 650 | MFI | ~250 nm to 2 μm |
| CBV 15014G | 150 | MFI | 30-100 nm |
| ZD12041 | 400 | MFI | 30 nm-100 nm |

### III. Method of Foam Preparation

In various embodiments, the PU foam is prepared by mixing all individual components, including at least one isocyanate-reactive component, at least one isocyanate component, at least one high silica zeolite, and any optional auxiliary additives such as catalyst, surfactant, additional blowing agents and any other additives at room temperature or at an elevated temperature of 25 to 200° C. (e.g., from 30 to 90° C. or from 40 to 70° C.) for a duration of 1-20 seconds, followed by an immediate pouring, spraying, injection or lay down of the resulting mixture into a mold cavity or a substrate for foaming. In some embodiments, optional auxiliary additives such as catalysts, flame retardants, additional blowing agent, and surfactants, etc., may be added to the isocyanate-reactive component or the isocyanate component prior to mixing with the other components or admixed with the other components online as separate streams.

In a preferred embodiment, the zeolite was added to the polyol blend and premixed, the isocyanate was then added and a final mixing was performed to ensure a homogeneous reaction.

Mixing may be performed in a spray apparatus, a mixing head, or a vessel Immediately after mixing, the foaming mixture may be sprayed or otherwise deposited or injected or poured onto a substrate or into a mold. Irrespective of any particular method of foam fabrication, the amount of the foaming mixture introduced into the mold or onto the substrate is enough to fully fill the mold or take the shape of a panel or any other functional shapes as the foam expands and cures. Some degree of overpacking may even be introduced by using a slight excess amount of the reaction mixture beyond minimally required. For example, the cavity may be overpacked by 5 to 35%, i.e., 5 to 35% by weight more of the reaction system beyond what is minimally required to fill the cavity once the reaction mixture is fully expanded at a pre-determined fabrication condition. This cavity may be optionally kept at atmospheric pressure or partially evacuated to sub-atmospheric pressure.

Upon reacting, the foaming mixture may take the shape of the mold or adheres to the substrate to produce a PU foam which is then allowed to cure, either partially or fully. The foam may also be allowed to rise freely at room temperature. Suitable conditions for promoting the curing of the PU polymer include a temperature of from about 20° C. to about 150° C. In some embodiments, the curing is performed at a temperature of from about 30° C. to about 75° C. In other embodiments, the curing is performed at a temperature of from about 35° C. to about 65° C. In various embodiments, the temperature for curing may be selected at least in part based on the time duration required for the PU polymer to gel and/or cure at that particular temperature. Cure time will also depend on other factors, including, for example, the usage amount of particular components (e.g., type and amount of catalyst), and the size and shape of the article being manufactured. Different articles being produced may include, but is not limited to, consumer comfort goods such as furniture, pillows, mattresses, as well as automotive applications (headliners, car seats, etc.) and any other application in which low odor PU foam may be desirable.

### Examples

Materials

The following components were used in the foaming formulation(s) tested. The exact amounts are listed below in Tables 1A, 1B and Table 2 below. DHN 395.01 Dev. Polyol is VORALUX HN 395, which is a polyether triol, having an OH No. of around 28 mg KOH/g, available from Dow. VORANOL 3943A is a copolymer polyol, having an OH No. around 30 mg KOH/g, and containing around 42% solids, available from Dow. VORANOL 4053 is a sucrose-initiated, 75% EO heterofeed cell opener polyol with a functionality of 6.9, available from Dow. Diethanolamine-85% is a solution of diethanolamine (85%) in water. VORASURF DC 5043 is a silicone surfactant with a hydroxyl number of around 28 mg KOH/g, available from Dow. DABCO 33LV is a 33 wt % solution of triethylenediamine in dipropylene glycol, available from Air Products. DABCO BL-11 is bis(N,N-dimethylaminoethyl)ether (70%) in dipropylene glycol. METATIN S-26 is stannous octoate. ABSCENTS 2000 Conc. is a hydrophilic zeolite additive, with a silica-to-alumina ratio of 6, available from Honeywell UoP. ABSCENTS 3000 Conc. is a hydrophobic zeolite additive, with a silica-to-alumina ratio of 630, available from Honeywell UoP. VORANATE T-80 is an 80/20 mixture of 2,4- and 2,6-isomers, respectively, of toluene diisocyanate, available from Dow.

TABLE 1A
Traditional Foaming Formulation Components

| | | | Formulation # Used | | |
|---|---|---|---|---|---|
| | | | 1 | 2 | 3 |
| | | | Formulation Name | | |
| | | PBW of Formulated Polyol Side | Ctrl Flex | Flex | Flex |
| Type | EW | Polyol Side Components | A | B | C |
| Polyol | 2040 | DHN 395.01 Developmental Polyol | 72.00 | 72.00 | 72.00 |
| Polyol | 1861 | VORANOL 3943A Copolymer | 28.00 | 28.00 | 28.00 |
| | | Polyol | | | |
| Polyol | 1795 | VORANOL 4053 Polyol | 1.50 | 1.50 | 1.50 |
| Additive | | DIETHANOLAMINE, 85% | 2.00 | 2.00 | 2.00 |
| Blowing | 9 | DEIONIZED WATER | 2.85 | 2.85 | 2.85 |
| Agent | | | | | |
| Additive | | DC 5043 | 1.15 | 1.15 | 1.15 |
| Catalyst | 101 | DABCO 33LV | 0.10 | 0.10 | 0.10 |
| Catalyst | 226 | Bis(N,N-dimethylaminoethyl)ether | 0.03 | 0.03 | 0.03 |
| | | (70%) in Dipropylene Glycol | | | |
| Catalyst | | STANNOUS OCTOATE S-26 | 0.07 | 0.07 | 0.07 |
| Zeolites | | ABSCENTS 2000 Conc. (wt %) | | 1.00 | |
| Zeolites | | ABSCENTS 3000 Conc. (wt %) | | | 1.00 |
| | | Isocyante Index | 108 | 108 | 108 |

TABLE 1B
Traditional Foaming Formulation Components

| | | | Total Wt | | |
|---|---|---|---|---|---|
| | | | 1900 | 1900 | 1900 |
| | | | Foam Setup/Machine | | |
| | | | box foam | box foam | box foam |
| | | | Desired Wts/Formulations # | | |
| | | | 1 | 2 | 3 |
| Type | Lot # | Polyol Side Components | A | B | C |
| Polyol | | DHN 395.01 Developmental Polyol | 960.65 | 953.9 | 953.9 |
| Polyol | | VORANOL 3943A Copolymer | 373.6 | 371.0 | 371.0 |
| | | Polyol | | | |
| Polyol | | VORANOL 4053 Polyol | 20.01 | 19.87 | 19.87 |
| Additive | | DIETHANOLAMINE, 85% | 26.68 | 26.50 | 26.50 |
| Blowing | | DEIONIZED WATER | 38.03 | 37.76 | 37.76 |
| Agent | | | | | |
| Additive | | DC 5043 | 15.34 | 15.24 | 15.24 |
| Catalyst | | DABCO 33LV | 1.33 | 1.32 | 1.32 |
| Catalyst | | Bis(N,N-dimethylaminoethyl)ether | 0.40 | 0.40 | 0.40 |
| | | (70%) in Dipropylene Glycol | | | |
| Catalyst | | STANNOUS OCTOATE S-26 | 0.93 | 0.93 | 0.93 |
| Zeolites | | ABSCENTS 2000 Conc. (wt %) | | 13.25 | |
| Zeolites | | ABSCENTS 3000 Conc. (wt %) | | | 13.25 |
| Type | Lot # | Isocyanate Side Components | A | B | C |
| Isocyanate | | VORANATE T80 | 463.03 | 459.80 | 459.80 |
| Isocyanate | | PAPI PB 219 Polymeric MDI | | | |
| | | Total Wt. of Formulated | 463.03 | 459.80 | 459.80 |
| | | Isocyanate | | | |
| | | Total Wt. of Form. Polyol + Isoc | 1.90 | 1.90 | 1.90 |

TABLE 2
List of Zeolites Tested

| | Manufacturer/ | Si/Al molar |
|---|---|---|
| Product | Supplier | ratio |
| ABSCENTS 2000 (ABS 2000) | Honeywell UoP | 6 |
| ABSCENTS 3000 (ABS 3000) | Honeywell UoP | 630 |

General Protocols for Foam Preparation and Testing

The 3 foams: Example 1, Example 2, and Comparative Example 1 were prepared and placed in a glass jar with a lid. The level of volatile compounds was measured by Headspace Gas Chromatography and a sensory panel. The foams created were also tested for flexibility and other mechanical properties. The results are discussed below.

Standard box foaming process was used to produce free rising foams at room temperature. The first step was to dose and premix in a pouring cup a reactive mixture containing all the polyols, additives, water, high silica zeolite, etc. Followed by strong final mixing to incorporate TDI using a high shear pin shape mixer. This reacting mixture was then poured into the wooden box of 15 in ×15 in ×10 in where the polyurethane foam was let to grow and cure overnight until it was cut for testing of its mechanical properties according to ASTM D 3574 and for sensory odor evaluation.

Two sets of foam samples were cut into pieces (1.5 cm×1.5 cm×30 cm) and placed into a 32 oz sensory jar at ambient temperature. One set of foam samples were used for internal sensory panel testing and the other set was used for Headspace Gas Chromatography analysis.

Internal sensory panel testing was conducted by four individuals. A blind testing protocol was followed with sample labeling unknown to participants. The skin of the box foam was removed using a saw blade and foams were placed next to each other. The panelist were allowed to smell each foam sample for −30 seconds and record the intensity from a scale of 0 to 5. In between each sample, panelist smelled the back of their hands to reset olfactory senses.

The following method and settings were utilized to analyze the foam samples by Headspace Gas Chromatography (GCxGC/TOFMS Method) by use of a LECO® Pegasus BT 4D GC×GC system with Liquid N₂ Cooled Thermal Modulator:
Gas Chromatograph: Agilent 7890 equipped with a LECO thermal desorption GCxGC modulator.
Columns: Primary column: Supelco Petrocol DH, 50 m×0.25 mm ID, 0.5 μm. Secondary column: DB-Wax, 1.5 m×0.10 mm ID, 0.10 μm film thickness. 0.89 m is in the 2^{nd} oven, 0.20 m in GC oven, 0.10 m in modulator and 0.31 m in MS transfer line.
GCxGC Modulation: Second dimension separation time: 3 sec, hot pulse time: 0.40 sec, cool time
Between stages: 1.10 sec. Modulator temperature offset: 15° C. above the primary oven.
Carrier Gas: Helium, 1.5 mL/min with corrected constant flow via pressure ramps.
Inlet: Split injection mode, split ratio: 30:1, temperature: 250° C.
Injection volume: 2000 μL by Gas-Tight Syringe.
Oven Temperature
Primary GC Oven: 40° C., 7 min, 3° C./min to 250° C., hold for 10 min.
Secondary Oven: +5° C. higher than oven temperature.
Modulator Temp: +15° C. higher than oven temperature.
MS: LECO Pegasus BT Time-of-Flight Mass Spectrometer.
Low Mass: 15.
High Mass: 300.
Acquisition Rate: 200 Hz.
Extraction Frequency: 30 Hz.
Electron Energy: −70 Volts.
Transfer Line: 250° C.
Ion Source: 250° C.
Solvent Delay: 0 minutes.
Software: ChromaTOF V5.40

Results

As shown in Tables 3A-3B, the foam formed with a high silica zeolite (Example 1) showed an enormous improvement in the reduction of volatile compounds acetaldehyde, propanol, acetone, acrylonitrile and styrene versus a traditional PU foam when measure by Headspace Gas Chromatography. The reduction was also much better than another foam formed with a low silica zeolite (Example 2).

TABLE 3A
Volatile Compounds Released from PU foams with Zeolites
measure by Headspace Gas Chromatography

| | Acetaldehyde | Propanal | Acetone | Acrylonitrile | Styrene |
|---|---|---|---|---|---|
| Odor Threshold | 1.5 ppb v/v | 1.0 ppb v/v | 42000 ppb v/v | 1.6 ppm | 35 ppb v/v |
| m/z Peak Area | 28.91 | 28.94 | 43 | 53.01 | 104.06 |
| PU foam control | 13042409 | 3961595 | 30126857 | 2145476 | 9783791 |
| PU foam + 1 | 3410222 | 1010094 | 14138079 | 1151705 | 7326499 |
| wt % ABS 3000 | | | | | |
| PU foam + 1 | 5312322 | 3387712 | 31827475 | 1240941 | 7774363 |
| wt % ABS 2000 | | | | | |

TABLE 3B
Volatile Compounds Headspace Reduction from PU foams with Zeolites

| | Composition | Acetaldehyde | Propanal | Acetone | Acrylonitrile | Styrene |
|---|---|---|---|---|---|---|
| Comparative | PU foam | 0% | 0% | 0% | 0% | 0% |
| Example 1 | control | | | | | |
| Example 1 | PU foam + 1 wt % | 74% | 75% | 53% | 46% | 25% |
| | ABSCENTS 3000 | | | | | |
| Example 2 | PU foam + 1 wt % | 59% | 14% | 0% | 42% | 21% |
| | ABSCENTS 2000 | | | | | |

Additionally, when tested by a Sensory Panel Example 1 resulted in an odor of less than 1 on a 0 to 5 scale. On this scale, 0 is the lowest amount of odor and 5 is the highest. The sensory panel testing was conducted by four individuals. A blind testing protocol was followed with sample labeling unknown to participants. The skin of the box foam was removed using a saw blade and foams were placed next to each other. The panelist were then allowed to smell each foam sample for approximately 30 seconds and record the intensity of smell from a scale of 0 to 5.

The untreated foam of comparative example 1 resulted in a very high score near 5 while the low silica zeolite foam resulted in a score close to triple that of Example 1.

TABLE 4
Sensory Panel Results

| Example | Odor (0-5) |
|---|---|
| Comparative Example 1 | 5 |
| Example 1 | 1 |
| Example 2 | 3 |

The mechanical properties of PU foams formed with zeolites incorporated were also tested under various protocols. The results of these tests can be seen in Table 5. As shown, there is little to no impact on the mechanical properties of a PU foam which has had a zeolite additive mixed into the formulation which formed the foam.

TABLE 5
Mechanical Testing

| Sample Description | 1 | 2 | 3 |
|---|---|---|---|
| Sample ID | 3943 Control | 1% of | 1% of |
| | | Zeolite 2000 | Zeolite 3000 |

ASTM D-3574-H Resilience (Ball Rebound) Test

| | | | |
|---|---|---|---|
| Average Resiliency | 45.20 | 46.00 | 48.20 |

ASTM D 3574-01 - Test B

| | | | |
|---|---|---|---|
| Hysteresis | 82.64 | 82.34 | 82.87 |
| Load @ 25% Deflection | 17.11 | 18.03 | 16.78 |
| Load @ 25% Return | 14.14 | 14.84 | 13.90 |
| Load @ 65% Deflection | 44.61 | 47.26 | 43.77 |
| Support Factor | 2.61 | 2.62 | 2.61 |

ASTM D 3574 G - Airflow dm3/s

| | | | |
|---|---|---|---|
| Mean | 1.717 | 1.446 | 1.780 |

ASTM D 3574-01 Test F - Tear test

| | | | |
|---|---|---|---|
| Tear strength mean | 1.96 | 1.88 | 1.61 |

ASTM D 3574-01 Test E - Tensile Test

| | | | |
|---|---|---|---|
| Elongation at break (mean), % | 123.177 | 120.767 | 124.422 |
| Tensile strength mean | 15.130 | 15.175 | 15.402 |

ASTM D 3574-03/D - CS 50% Compression Test

| | | | |
|---|---|---|---|
| CD | 8.7703 | 9.6538 | 10.5399 |
| CT | 4.5157 | 4.9541 | 5.4857 |

ASTM D1622-03 - Free Rise Density

| | | | |
|---|---|---|---|
| Density | 2.264 | 2.259 | 2.223 |
| Test Comments | 36.2 | 36.2 | 35.6 |

1. A foam-forming composition for preparing polyurethane foams, comprising:
at least one isocyanate component;
at least one isocyanate-reactive component; and
at least one silica containing zeolite additive, wherein the silica containing zeolite has an Si/Al molar ratio of greater than 35.

2. The foam-forming composition of claim 1, wherein the silica containing zeolite has an Si/Al molar ratio of greater than 100 and less than 700.

3. The foam-forming composition of claim 1, wherein the silica containing zeolite has an Si/Al molar ratio of greater than 500 and less than 700.

4. The foam-forming composition of claim 1, wherein the at least one silica zeolite additive is present in an amount ranging from 0.1 to 20 wt % of the total foam-forming composition.

5. The foam-forming composition of claim 1, wherein the at least one silica zeolite additive has a pore size or less than 10 Å.

6. A polyurethane foam produced from the composition of claim 1, wherein the total aldehydes present are less than 10 ppm.

7. A polyurethane foam produced from the composition of claim 1, wherein the foam is produced at up to 200° C.

8. The foam-forming composition of claim 1, wherein the silica containing zeolite has an Na wt % of less than 2.

9. A method of producing a polyurethane foam from the foam-forming compositions of claim 1.
